(19) United States
(12) Patent Application Publication
(10) Pub. No.: US 2013/0160206 A1
(43) Pub. Date: Jun. 27, 2013

(54) Bib Sheet Poop Sheet System

(71) Applicant: Ian Campbell Cree, Churchover (CA)

(72) Inventor: Ian Campbell Cree, Churchover (CA)

(21) Appl. No.: 13/487,630

(22) Filed: Jun. 4, 2012

Related U.S. Application Data
(60) Provisional application No. 61/579,748, filed on Dec. 23, 2011.

(51) Int. Cl. A47G 9/02; A61G 9/00

(52) U.S. Cl. 5/484

(57) ABSTRACT

Bed-ridden patients may need to be removed from their beds several times a day, for changing of soiled linens, or showering. This may create an exceptional burden on cardiac, paralyzed, traumatized, post-operative, burned or obese patients. It also takes a toll on medical staff and caretakers. Close monitoring of fluid balance in such patients and those suffering from vomiting, diarrhea, incontinence, or bodily discharges, is often required, but currently such fluid losses cannot be measured. Handling of contaminated sheets can spread life threatening infections, and replacement of stained sheets is costly. The Bib sheet Poop sheet System addresses these problems and the problem of pressure sores.

The Bib sheet, Poop sheet and Poop mattress may be made of impervious fabric to protect the patient's clothing, underlying sheets and mattress. A porous mat and marginal rim conduct fluids down to tubes draining into measuring buckets at the foot of the bed.

This application claims priority from Provisional Application: 61/579,748 filed on Dec. 23, 2011.

### BACKGROUND OF PROBLEM

Bed-ridden patients may need to have the linens on their bed changed frequently, which requires them to be removed from the bed. This process, which may occur several times per day, can be time consuming and may create an exceptional burden on cardiac, paralyzed, seriously traumatized, post-operative, burned, or obese patients. It also takes a toll on busy medical staff and caretakers. If any stains cannot be removed, new sheets and mattresses must be purchased, which can be costly. Also, medical personnel try to monitor fluid balance closely in bed-ridden cardiac, traumatized, post-operative, and burned patients, or those suffering from repeated vomiting or diarrhea. Currently there is no way to determine the total amount of fluid loss when a patient has any of these conditions. If patients have an infection, vomiting, incontinence or diarrhea, contaminated sheets handled by multiple people could spread potentially lethal infection. A more sanitary and efficient solution is necessary.

The Bib Sheet Poop Sheet System of the present invention is designed to give comfort to bed-ridden patients and make it easier for care-givers to maintain a clean environment for the patient and for the care-giver(s). The system may have three components: a bib sheet, a poop sheet and a poop mattress. All three may be made from an impervious fabric that can protect underlying bed sheets or the patient's clothing from soiling, because of open, discharging wounds, vomit, food spills, diarrhea, or incontinence. Any liquid may flow off the material and down to the edge of the sheet, which has an attached rim that conducts everything into drainage pipes and buckets at the foot of the bed. Hospitals, hospice centers, nursing homes and homes, in which families take care of bed-ridden patients may appreciate the efficiency and functionality of this innovative product.

### DETAILED DESCRIPTION OF INVENTION

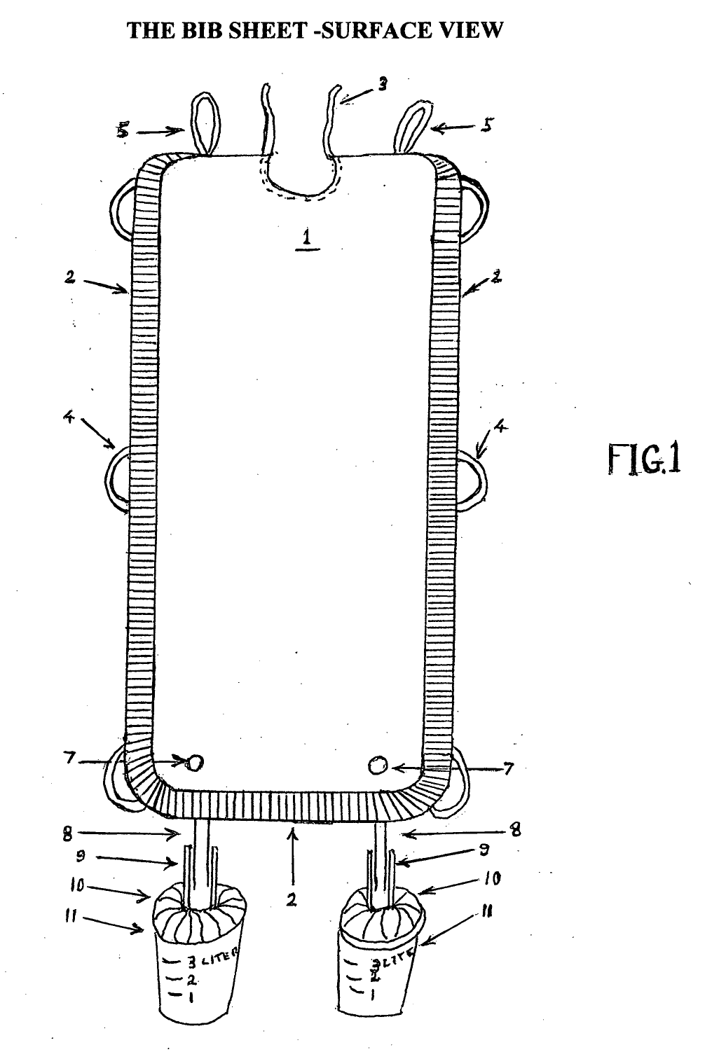

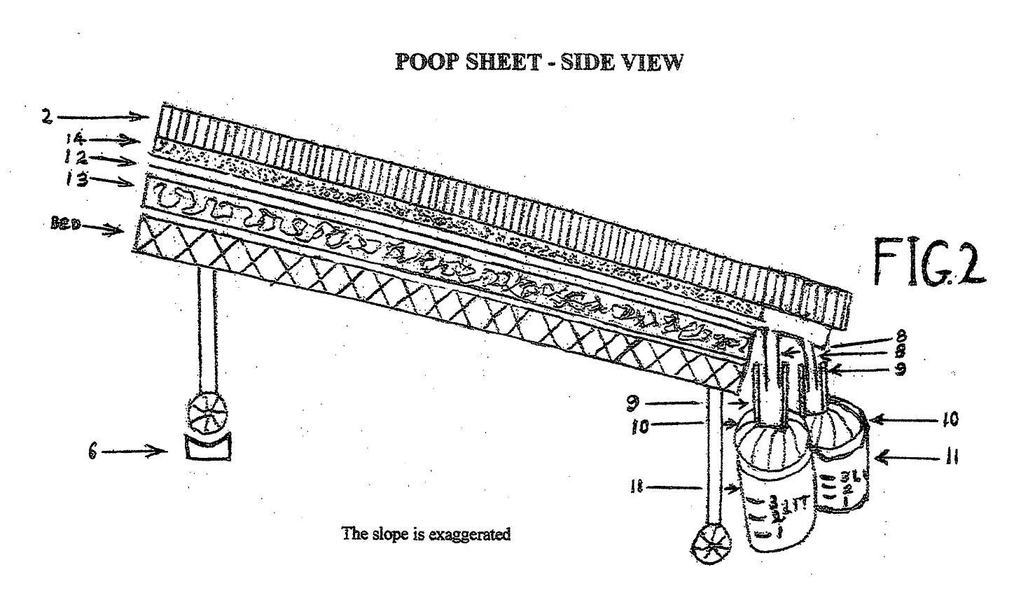

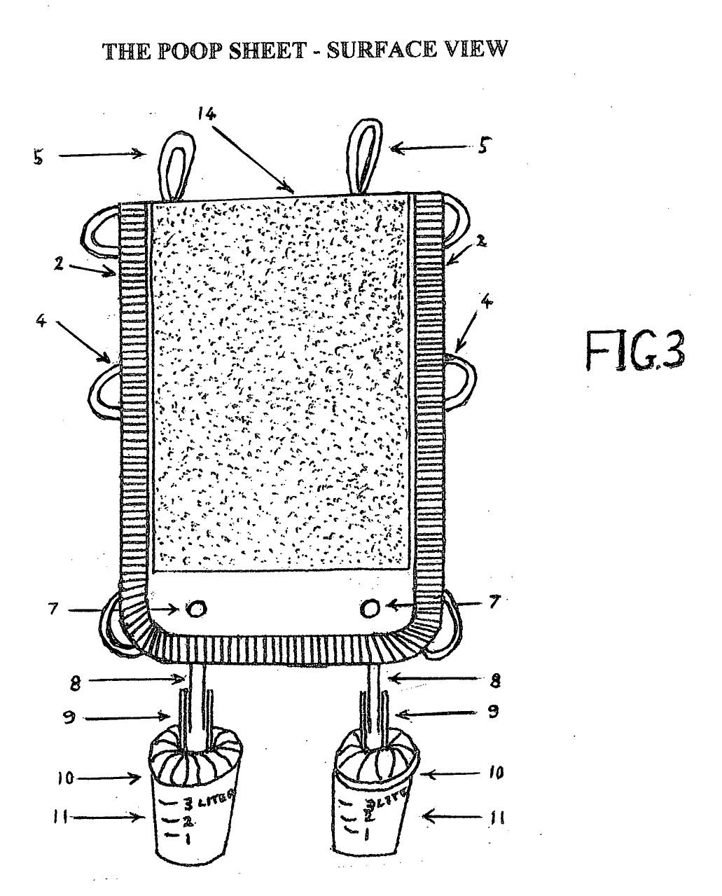

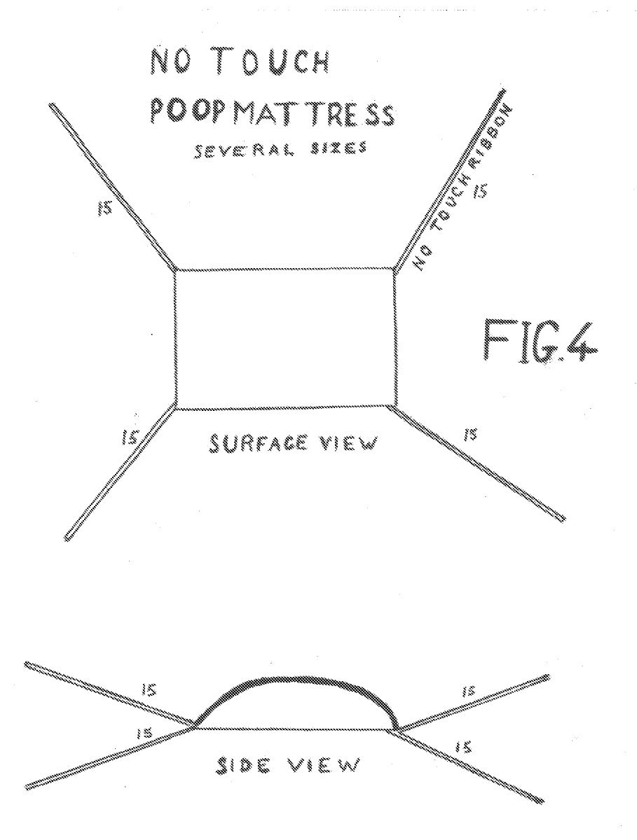

The Bib Sheet Poop Sheet System provides care-givers with a way to protect linens and make the daily routine of caring for a bed-ridden individual less demanding. The system preferably has three components: a bib sheet [FIG. 1], a poop sheet [FIGS. 2 and 3], and a poop mattress [FIG. 4].

The Bib Sheet may be made from a single piece of waterproof material (1) with a molded, attached, flexible rim (2) along the edges. The rim may measure approximately 6″ high and 2″ wide at the base, tapering in a triangular fashion to a rounded top. The length and width of the rim in other dimensions of the invention may vary according to the size of the bed. The sheet may have an opening at the top for a user's neck to fit comfortably. A cord (3) may tie behind the neck to secure the sheet in place. In six other places along the edges at the base of the rim, externally, there may be looped handles (4), that can help a caretaker carry the sheet without touching it. Two loops at the upper end of the sheet (5) may allow it to be hung from hooks for spray cleaning, disinfection and drying in other locations, such as a laundry or shower enclosure.

The bed should have a gentle slope down to the foot of the bed, and the head of the bed may be placed on blocks (6) to provide for gravity drainage. The bottom corners of the sheet may have two round openings (7) where drainage pipes (8) may fit tightly. The drainage pipes may be removably inserted into larger pipes (9) that are connected to the removable lids (10) of two translucent buckets (11), with measurement markers on the sides to gauge fluid loss. The buckets will have handles for carrying, which are not shown in the sketches.

The Poop Sheet may resemble the Bib Sheet, but it may be made from a stronger material (12) and placed directly on top of a bed sheet or mattress (13) and underneath the patient. It may include a removable spongy porous plastic mat (14) that measures at least 2″ thick. The porous mat should have large pores to allow free flow through it, for semi-solid material. It may fit snugly inside the rim (2) and help to prevent bed sores in a patient. For very heavy patients, the thickness of the porous mat (14) may need to be higher and the rim (2) also. The product is ideal for patients who are incontinent of urine, stools, or both, and for patients who have diarrhea, colostomies, ileostomies, or fistulae, as well as those patients whose drainage tubes or catheters may become displaced, or accidentally pulled out.

The Poop Sheet may also allow a patient to have a shower while sitting up in bed. A Shower curtain may hang from the ceiling and be tucked inside the rim (2). The curtain may have weights sewn or fused into the bottom hem to ensure that it will stay within the rim. A care-giver may connect a shower head, or hose nozzle, to a hose and water source, and turn the water on. The buckets (11) at the foot of the bed may be replaced with a flexible pipe that can extend into a bathroom, kitchen, or another room with a suitable drain fixture.

The Poop Mattress is a disposable covering that may be placed on top of the Poop Sheet to act as an extra layer of comfort for the patient. It may be comprised of a spongy plastic material, or any soft, absorbent material with a soft cover, similar to a pillow. It may have four ribbons, (15), one for each corner, for easy, no-touch removal. The size may be big enough to cover a patient's backside, with variable sizes made available. The exact specifications, materials used, and method of use of the Bib Sheet Poop Sheet System may vary upon manufacturing. When both a Bib sheet and a Poop sheet are used, the rim of the Bib sheet should be large enough to accommodate the rim of the Poop sheet.

### DETAILED DESCRIPTION OF DRAWINGS ATTACHED

FIG. 1 Shows a sketch of the surface view of the Bib Sheet. [Note that the sheet reaches both the sides and the foot of the bed.]

FIG. 2 Shows a sketch of the side view of the Poop Sheet. [Note that the slope of the bed is exaggerated to emphasize the need for gravity drainage, and that the bed mattress is fully protected.]

FIG. 3 Shows a sketch of the surface view of the Poop Sheet.

FIG. 4 Shows a sketch of the Poop Mattress.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

### SEARCH RESULTS OF PRIOR ART

US Patent Search for US Provisional Patent

The embodiments of the invention in which an exclusive property or privilege is claimed are defined as follows:

1. An impervious Bib sheet which completely covers bed linen and a patient's clothing to protect them from vomit, food spills, blood, pus or wound discharges, with an attached rim to the sheet, which directs the flow of fluids down to the foot of the bed and into two corner drainage tubes, under the influence of gravity, and so into translucent buckets, having markings in liters and fractions thereof on the buckets, for accurately determining fluid losses to maintain the patient's fluid balance, and having removable lids, to which are centrally attached drainage tubes, wider than, and for receiving, the corner drainage tubes, as well as a means for removing the protective sheet for cleaning, by a series of handles external to the rim which avoids contact with the contaminated surface, as well as loops for suspending the sheet in a cleaning location, such as a laundry or shower enclosure, where spray cleaning with water and a disinfectant can be carried out.

2. An impervious Poop sheet, similar to the Bib sheet, but of sturdier material and extending only a little behind the buttocks, surrounded in like manner by a rim which directs fluid and semisolid matter down to the foot of the bed into like drainage tubes and like wider receiving tubes, connected to the lids of like measuring buckets, on top of which is an, at least, two inch thick removable spongy plastic mat, with pores large enough for the passage of semisolid matter, which fits snugly within the rim and lies on top of the poop sheet, allowing for a shower curtain with enclosed weights at the bottom to retain the curtain within the rim of the Poop sheet; and for comfort, a soft Poop mattress, similar to a pillow, the approximate size of the patient's buttocks with four corner tails for no contact removal, thus, along with the other no contact measures, providing a great reduction in the risks of transmitting potentially lethal Bacterial and Viral infections, as well as the production of decubitus ulcers. (Pressure sores).

3. Colossal financial savings by using simple techniques and materials for manufacture of the Bib and Poop sheets, avoiding costs of expensive equipment, such as pumps and dehydrators, saving on power for running equipment, saving on bed linen, special mattresses, dressings, antibiotics, and surgical procedures for pressure sores, while greatly diminishing the exhausting work of all staff and care-takers.
